(19) United States
(12) Patent Application Publication
(10) Pub. No.: US 2009/0234677 A1
(43) Pub. Date: Sep. 17, 2009

(54) Traffic arrest insurance and methods therefor

(76) Inventor: Alexander I. Arezina, Elmhurst, IL (US)

Correspondence Address: Alexander I. Arezina, 301 Geneva Ave., Elmhurst, IL, 60126, US

(21) Appl. No.: 12/075,396

(22) Filed: Mar. 11, 2008

(51) Int. Cl. G06Q 40/00

(52) U.S. Cl. 705/4

(57) ABSTRACT

A method of insuring expenses related to a traffic arrest comprises collecting underwriting data from a prospective customer and issuing an insurance policy to the prospective customer, the prospective customer becoming an insured under the insurance policy. The method further comprises determining the occurrence of a covered loss, the covered loss comprising the insured being arrested for a traffic infraction included in a group of covered traffic infractions under the insurance policy, and paying a first payment for the purposes of paying covered traffic infraction related expenses.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to insurance products and methods for providing insurance, and more particularly, to traffic arrest insurance and methods for providing the same.

### BACKGROUND OF THE INVENTION

Personal insurance products have been a cornerstone of the insurance industry for many years. Generally, such products have included automobile insurance, homeowner's insurance, renter's insurance, and umbrella liability policies. In addition to personal insurance products, commercial insurance products continue to grow in sales each year and include such products as commercial automobile insurance and garage liability insurance. Because insurance products and services are heavily regulated by various states, localities, and other jurisdictions, coverage offerings from various insurers tend to be similar due to industry standardization, and thus pricing for such insurance products is often very competitive. Thus, clever insurance companies have turned to offering additional or ancillary products or services to distinguish themselves in the market place and entice customers to purchase insurance.

Generally, the appeal of certain insurance products to potential purchasers is dependent upon price and perceived value. Such perceived value may include quality of service, ease of claims processing, availability of resources and other factors. Price, however, is frequently based upon the same or similar underwriting factors, such that prices amongst various insurance companies are often quite competitive. Thus, ancillary products or services may influence potential purchasers of insurance to choose a particular insurance company as their provider.

The present invention relates to a new category of insurance products which may be offered by insurance companies to current and prospective customers. Disclosed and described herein is the product of traffic arrest insurance coverage which can be offered in the form of supplemental coverage, endorsements, or standalone insurance policies.

### SUMMARY OF THE INVENTION

According to one aspect of the present invention, a method of insuring expenses related to a traffic arrest comprises collecting underwriting data from a prospective customer and issuing an insurance policy to the prospective customer, the prospective customer becoming an insured under the insurance policy. The method further comprises determining the occurrence of a covered loss, the covered loss comprising the insured being arrested for a traffic infraction included in a group of covered traffic infractions under the insurance policy, and paying a first payment for the purposes of paying covered traffic infraction related expenses.

According to another aspect of the invention, a method of offering traffic arrest insurance comprises receiving a request for automobile insurance from a prospective customer, collecting underwriting data from the prospective customer, and offering to the prospective customer supplemental insurance coverage comprising traffic arrest insurance. The traffic arrest insurance covers traffic arrest related expenses. The method further comprises receiving from the prospective customer acceptance of the offer of supplemental insurance and issuing both an automobile insurance policy and the supplemental coverage to the prospective customer wherein the prospective customer becomes an insured under the automobile insurance policy.

According to yet another aspect of the invention, a method of paying traffic arrest related expenses under an insurance policy comprises receiving a claim for payment from an insured and determining that the insured is covered under at least one insurance policy including traffic arrest expense coverage. The traffic arrest coverage covers traffic arrest related expenses. The method further comprises determining a covered loss has occurred, the covered loss comprising the insured being arrested for a covered traffic infraction, and paying covered expenses related to the adjudication of the traffic infraction either (i) to the insured or (ii) on the insured's behalf.

According to yet another aspect of the invention, a method of collecting data for underwriting traffic arrest insurance coverage comprises collecting initial underwriting data from one or more prospective customers applying for traffic arrest insurance coverage and issuing one or more traffic arrest insurance policies to the one or more insureds, the one or more traffic arrest insurance coverage policies covering traffic arrest related expenses. The method further comprises receiving claim information from the one or more insureds when claims are made under the traffic arrest insurance policies, compiling the received claim information and the initial underwriting data, analyzing the compiled data, and in response to the analysis, adjusting the price of future traffic arrest insurance coverage offered.

According to yet another aspect of the invention, a method of compensating an insurance agent for selling traffic arrest insurance coverage comprises determining an occurrence of an authorized sale of a traffic arrest insurance policy to an insured by an insurance agent, wherein the traffic arrest insurance policy covers traffic arrest related expenses and determining a price of sale of the traffic arrest insurance policy. The method further comprises calculating a commission to be paid to the insurance agent, the commission based at least in part on the price and paying the commission to the agent.

According to yet another aspect of the invention, one or more computer readable storage media is encoded with instructions for directing a computer to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a flowchart of a method of insuring expenses related to a traffic arrest.

FIG. 2 is a flowchart of a method of method of offering traffic arrest insurance.

FIG. 3 is a flowchart of a method of paying traffic arrest related expenses under an insurance policy.

FIG. 4 is a flowchart of a method of collecting data for underwriting traffic arrest insurance coverage.

FIG. 5 is a flowchart of a method of compensating an insurance agent for selling traffic arrest insurance coverage.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

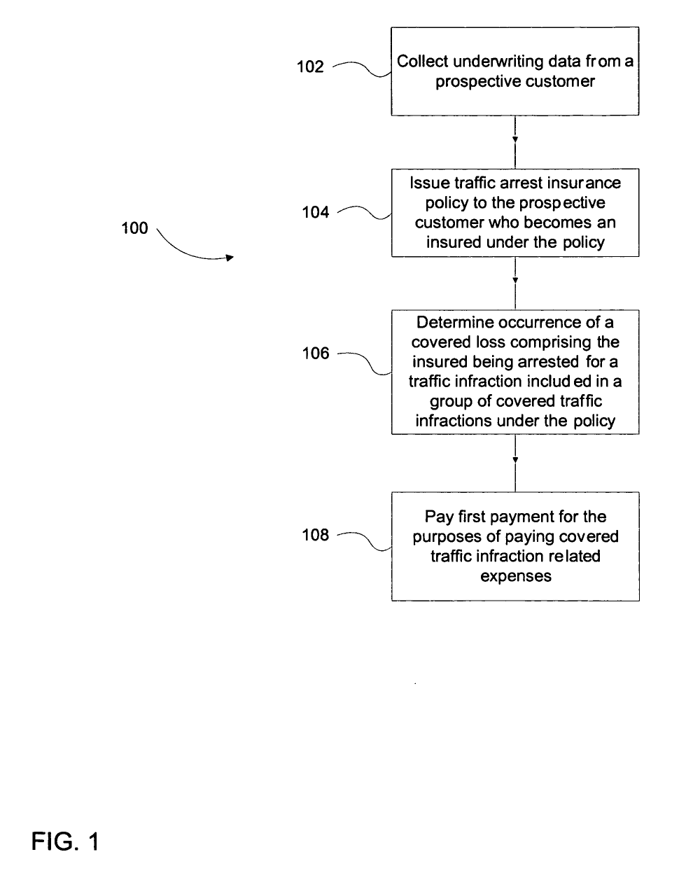

Referring to FIG. 1, a flowchart of a method 100 of insuring expenses related to a traffic arrest is depicted. At step 102, underwriting data is collected from a prospective customer. As step 104, a traffic arrest insurance policy is issued to the prospective customer, where the prospective customer becomes an insured under the policy. At step 106, the occurrence of a covered loss is detected and determined, wherein the covered loss comprises the insured being arrested for a traffic infraction included in a group of covered traffic infractions under the insurance policy issued. At step 108, a first payment is paid for the purposes of paying covered traffic infraction related expenses.

In the method 100, the underwriting data may include personal data such as name, address, telephone number, social security number, driver's license number, and other identifying information. Other underwriting data may include marital status, credit score, age, driving record, vehicle information, educational background, employment information, claims history, home ownership, etc. The underwriting data may also include traffic citation, arrest, and conviction history data. The underwriting data may be collected directly from the prospective customer, or may be compiled from secondary sources using other information, such as the personal data collected. For example, a person's social security number or driver's license number may be used to cross-reference databases such as those maintained by a state or locality's motor vehicle division or secretary of state.

Moreover, the insurance policy is issued to the prospective customer who becomes an insured. However, the policy may include other people as insureds under the policy. For example, the prospective customer's spouse, children, parents, or other family or household members may become insureds under the policy as well. Moreover, certain eligibility criteria may be placed on such additional individuals in order that they may qualify as insureds under the policy. In one embodiment, the prospective customer's family members become insureds under the policy only if they reside with the prospective customer. Many other varieties of eligibility criteria may be employed as well in determining whether or not certain individuals are insureds under the policy. Moreover, in step 102, the collected underwriting data may pertain to those other than the prospective customer who may become insured under the policy.

A covered loss may be detected or determined using a number of methods. For example, an insured under the policy may file or initiate a claim with the insurance company issuing the policy. The claim may be initiated in writing, in person, telephonically, or electronically (using email or over the internet, for example, using a website interface provided by the insurance company or its agent or representative). The filing of the claim may require the insured to submit certain information and/or evidence to assist the insurance company in determining whether or not the claim is covered by the insurance policy. In one embodiment, the insured must submit their traffic ticket, summons, citation, or other arrest related paperwork as evidence that the arrest has in fact occurred. The insurer, in turn, may use this information to determine whether the offense for which the insured has been arrested is a covered offense under the policy language.

First and foremost, because the policy is designed to provide coverage in the event that an insured is arrested for a covered traffic infraction, the coverage determination requires that proof of the arrest be provided. For example, the insured may have to submit evidence of the arrest in the form of a copy of the citation, ticket, summons, or other charging papers issued to the insured by the arresting officer or agency. The coverage determination further requires that the traffic infraction be a covered traffic infraction under the policy. Thus, a comparison must be made between the offense with which the insured is charged and the enumerated, listed, or categorized traffic offenses covered by the policy. Finally, the coverage determination may also depend on (and therefore require) investigation of other ancillary matters. For example, the insurance company may need to verify that the traffic arrest occurred during the active policy period, that the policy premium was fully and timely paid, that the insurance policy limits have not been exhausted, and that other exclusions under the policy do not apply. Provided that these matters are all resolved favorably, the determination of a covered loss may be made.

Payment of the first payment may comprise a variety of payments which together are referred to as “the first payment.” For example, in one embodiment, the first payment is paid directly to the insured. In another embodiment, the first payment may be made to one or more third parties to whom traffic infraction related expenses are due and owing. For example, if the policy includes court costs and traffic fines as covered traffic infraction related expenses, those expenses may be paid as part of the first payment by issuing payment to the clerk of the court in which the conviction was rendered. The first payment may be a predetermined amount, such as a fixed payout amount or policy limit which is paid to the insured in response to a covered loss. Alternatively, the first payment may be a variable amount which depends on the amount of covered traffic infraction related expenses which are submitted by the insured in a claim. The policy or coverage may include a policy or coverage limit as well, such that the first payment amount may be the lesser of the policy/coverage limit or the submitted covered expenses. As used herein “coverage” and “policy” are used interchangeably, regardless of whether the traffic arrest insurance coverage is provided as a standalone policy, or as an optional coverage or endorsement to some other insurance policy or coverage.

Additionally, many variations or additions to the steps of the method are possible in various embodiments. In one embodiment, the first payment is a predetermined amount which is based upon a policy premium collected from the insured. Thus, in such an embodiment, the more coverage an insured desires, the greater policy premium he or she must pay. Moreover, in such an embodiment, the fixed predetermined amount is paid out as the first payment regardless of the actual costs or covered traffic related expenses incurred due to the covered loss. The insured would need to demonstrate in such an embodiment that a covered loss has occurred in the form of his or her arrest for a covered traffic infraction. Once a covered loss is determined, as described herein, the first payment is issued in an amount indicated in the insurance policy.

In one embodiment, the group of covered traffic infractions is limited to common motor vehicle citations. For example, the covered traffic infractions may include speeding, reckless driving, DUI, failure to obey a traffic signal or sign, improper lane change, improper turn, following too closely, etc. In other embodiments, the covered traffic infractions may further include other offenses more administrative in nature such as driving on a suspended license, driving without a license, expired license plates, expired stickers, expired drivers' license, lacking proof of liability insurance, etc. In yet other embodiments, the insurance policy need not be limited to traffic related infractions or offenses, and may be expanded to non-traffic and non-vehicular crimes. For example, the insurance policies may be issued to cover expenses related to arrests for various misdemeanors and felonies, including assault, battery, drunk in public, obstruction of justice, disorderly conduct, drug offenses, fleeing the scene of an accident or crime, etc.

In alternative embodiments, the method 100 may further comprise additional steps. For example, an optional step may comprise receiving a policy premium payment from the insured. The policy premium may be paid in a variety of ways. For example, the premium may be paid in one lump-sum payment at or near the time of issuance of the policy. Alternatively, the premium may be paid periodically, such as monthly, weekly or quarterly. One or more convenience fees may be charged to the insured based upon the payment plan selected by the insured in an effort to offset the additional costs of providing such alternative payment plans. In another alternative embodiment, once the entire amount of a policy limit of the insurance policy is paid, the method 100 may include an optional step of declaring the policy limits exhausted. The policy premiums may be paid to the insurer directly by the insured (“direct bill”) or alternatively may be paid to the insurer by an insurance agent who collects the policy premium from the insured (“agency bill”).

In one embodiment, the covered traffic infraction related expenses comprise court costs and fines associated with the traffic arrest and/or conviction. In other embodiments, a number of other expenses may be enumerated as covered traffic infraction related expenses under the policy. For example, the covered traffic infraction related expenses may include bail and bond payments made in connection with the traffic arrest. This may further include payments for posting a bond or bond card so as to avoid being physically detained, brought to jail, or otherwise incarcerated. The covered expenses may further include rehabilitation programs and efforts, such as substance abuse programs, counseling, psychological or psychiatric intervention, addiction intervention, education programs, and other well being care, whether voluntary or court mandated.

In yet other embodiments, the covered traffic related expenses may include vehicle related expenses, such as costs associated with towing, impoundment of the insured's vehicle, and rental vehicle charges as a result of, and necessitated by the traffic arrest. Vehicle impoundment and forfeiture may occur not only as a consequence of the arrest, but under many laws may be imposed as a result of a conviction on certain charges. Other vehicle related expenses may comprise equipment expenses such as the installation of ignition interlock devices which prevent a vehicle from being operated if alcohol or other impairing substances are detected on the driver. In yet another embodiment, the expenses of hiring an attorney to defend the insured in the prosecution of the traffic arrest may be covered expenses. Thus, fees and costs paid to a criminal defense attorney, for example, may be covered traffic infraction related expenses as well. Many other expenses related to the traffic arrest may be covered as well under such a policy.

In yet other alternative embodiments, covered traffic infraction related expenses may include payment of increased insurance automobile insurance premiums due to conviction of a traffic offense. For example, the covered traffic infraction related expenses may cover the differential between an insured's automobile policy premium pre-conviction and post-conviction. Alternatively, the covered expenses may include payment of the entire premium of the increased premium for the auto policy, or any portion thereof. Yet other covered expenses may include driver's license application, re-application and reinstatement fees. Moreover, with the advent of jurisdictions and localities charging municipal response fees (fees for services provided by fire, police, rescue and other civil service personnel), these fees may be included as covered traffic infraction related expenses.

Additional covered traffic infraction related expenses may include post-conviction administrative expenses such as obtaining and providing proof of financial responsibility, filing financial responsibility documents with appropriate agencies, registration requirements (such as registering your identity and/or driver's license with a state or local governmental body, e.g. SR-22 compliance). An SR-22 is an official documentation required in some states to redeem a suspended drivers' license and allow the driver to get his or her car registered at the local Department of Motor Vehicles (DMV). A SR-22 Filing is a form issued by an insurance company which removes a suspension order placed by the DMV's office on your driving privilege. The filing provides a guarantee to the state that an insurance company has issued at least minimum liability coverage for the person making that filing and that the insurance company will notify the DMV should the insurance ever lapse for any reason. SR-22 differs from the standard SR-1 form required for accidents or other traffic violations in that is it specific to a DUI violation.

As used herein, “arrest” or “arrested” refers to the process of being charged with a traffic offense. Thus, the terms “arrest” and “arrested” are intended to designate any mechanism with which a person is charged with a traffic infraction, and include but are not limited to a summons, a traffic citation, a ticket, criminal indictment, criminal information, grand jury subpoena, or other mechanism for charging a crime or other offense. Thus, the term “arrest” is to be broadly construed to cover any such mechanism which causes and requires a person to appear in court to answer for and/or defend against an accusation that he or she committed a traffic or criminal offense. In one embodiment, an “arrest” may trigger coverage as described herein, regardless of whether such an arrest ultimately leads to a conviction, the charges are dropped, or are otherwise amended or reduced to lesser offenses which may or may not be enumerated as covered offenses, or may be otherwise excluded.

As used herein, DUI refers to a group of offenses commonly known as “Driving Under the Influence” or “Driving While Intoxicated.” DUI is meant to be broadly construed to cover the various labels assigned to such an offense in various jurisdictions. DUI refers to the criminal or traffic offense which punishes the act of operating a motor vehicle after having consumed alcohol or other drugs to the degree that mental and motor skills are impaired. The specific criminal offense may be called, depending on the jurisdiction, driving while intoxicated (DWI), driving while impaired (also DWI), operating while intoxicated (OWI), operating a motor vehicle while intoxicated (OMVI), driving under the influence [of alcohol or other drugs] (DUI), driving under the combined influence of alcohol and/or other drugs, driving under the influence per se or drunk in charge [of a vehicle].

In the United States, statutes commonly provide for two separate and distinct criminal offenses, both of which are included in the definition of “DUI” as used herein. The first is the traditional “drunk driving” offense, consisting of driving under the influence of alcohol and/or drugs. Evidence to support this crime generally comes from the officer's observations (erratic driving, slurred speech, unsteady gait, etc.), performance on field sobriety tests, and a legal (and generally rebuttable) presumption of intoxication from a blood alcohol test result over the legal limit. The second offense is the more recent so-called “per se” offense: rather than focusing on impairment the crime consists entirely of having a given blood alcohol content (BAC) at the time of driving, regardless of the individual's tolerance to alcohol. Both offenses may be charged, and the defendant may be convicted of both; if a blood alcohol test result was not obtained, only the “traditional” drunk driving or impaired driving offense may be charged. In foreign countries, a variety of similar laws punishing impaired driving due to alcohol and/or drugs exist, and are included herein in the definition of “DUI.”

As used herein, the terms “offense,” “infraction,” “citation” and “violation” are used interchangeably to indicate an occurrence prohibited by a relevant traffic law, statute, regulation, or ordinance. Thus, an act done by an individual in contravention of such a law, statute, regulation or ordinance may be referred to as an offense, infraction, citation, violation or other similar term.

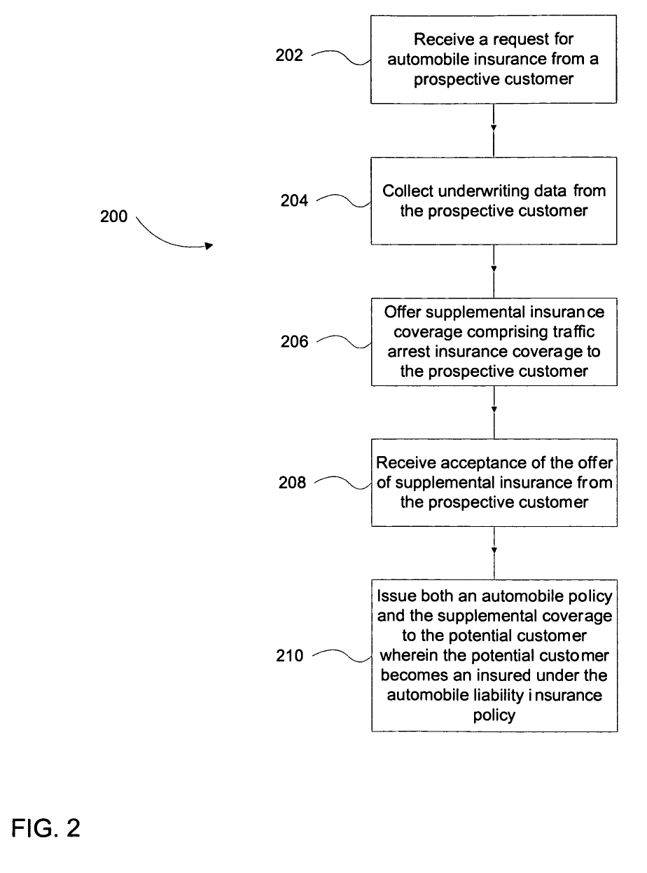

Referring to FIG. 2, a flowchart of a method 200 of method of offering traffic arrest insurance is depicted. At step 202, a request for automobile insurance from a prospective customer is received. At step 204, underwriting data from the prospective customer is collected. At step 206, supplemental insurance coverage comprising traffic arrest insurance is offered to the prospective customer. The traffic arrest insurance covers traffic arrest related expenses. At step 208, acceptance of the offer of supplemental insurance is received from the prospective customer. At step 210, both an automobile insurance policy and the supplemental coverage are issued to the potential customer wherein the potential customer becomes an insured under the automobile insurance policy.

The method begins with a request from a prospective customer for automobile insurance being received. Customers may be shopping for automobile liability coverage, physical damage coverage, and other associated coverages such as medical payments, uninsured and underinsured coverage, etc. Thus, the method, as described herein offers the invention of traffic arrest insurance in conjunction with a request for traditional automobile insurance.

The request from the prospective customer may be received in a variety of manners. For example, the request may be received in person, telephonically, in writing, or electronically (e.g. email, internet, etc.). In one embodiment, the prospective customer may initiate a request electronically via email or a website provided and operated by or on behalf of the insurance company issuing the traffic arrest insurance coverage or policy. For example, insurance companies offering such coverage may operate interactive websites accessible on the internet which prospective customers may use to initiate such a request. Similarly, underwriting data may be collected from the prospective customer in one or more of the same manners. In the internet example, the website may prompt a user to input certain underwriting data, including personal data and traffic history data as described previously herein. Moreover, the request may be delivered via an intermediary such as an insurance agent, as described elsewhere herein.

Similarly, the step of offering supplemental insurance in the form of traffic arrest insurance covering traffic arrest related expenses may be accomplished in a number of ways. Such insurance may be offered in writing, in person, telephonically or electronically. In the internet example described above, upon completion of the underwriting process, a decision may be made to either insure the potential customer or not. If coverage is to be offered to the potential customer, it may offered via the internet site and inform the potential customer of the details of the offer. Alternatively, the offer may be made by email to the customer. The manner in which the offer is made may be the same as or different from the manners in which the request is received from the customer and the underwriting data is collected.

Both an automobile policy and the supplemental traffic arrest coverage are issued to the prospective customer. The traffic arrest coverage may be embodied in one or more endorsements to the automobile insurance policy. Alternatively, the traffic arrest coverage may be provided as one or more optional coverages contained in the automobile insurance policy. In yet another embodiment, the traffic arrest coverage may be provided in a separate or standalone policy. In one embodiment, the prospective customer becomes an insured under the automobile policy. In other embodiments, the prospective customer may also become an insured under one or more additional policies, for example a standalone policy containing the traffic arrest coverage. As before, the covered traffic related expenses may comprise a variety of expenses incurred as a consequence of the arrest and/or a conviction related to the traffic infraction charged.

It should be understood that any of the transactions between the insurance company issuing such traffic arrest coverage and an insured or prospective customer may occur either directly, or via an intermediary. In one embodiment, the intermediary may be an insurance agent. The insurance agent may be an independent agent or may be an internal agent, such as an employee or captive of the insurer. In transacting business through the agent, any steps of the methods described herein may be conducted through the intermediary. For example, the request for automobile insurance in step 202 may be made by the prospective customer to an intermediary, such as an insurance agent, who in turn relays the request to an appropriate insurance company. Likewise, issuance of the policy from the insurance company to the insured may be made via the insurance agent intermediary. Many other interactions between the insured and the insurance company (e.g. claims, payment, amendments in coverage, etc.) may be accomplished via the agent or other intermediary.

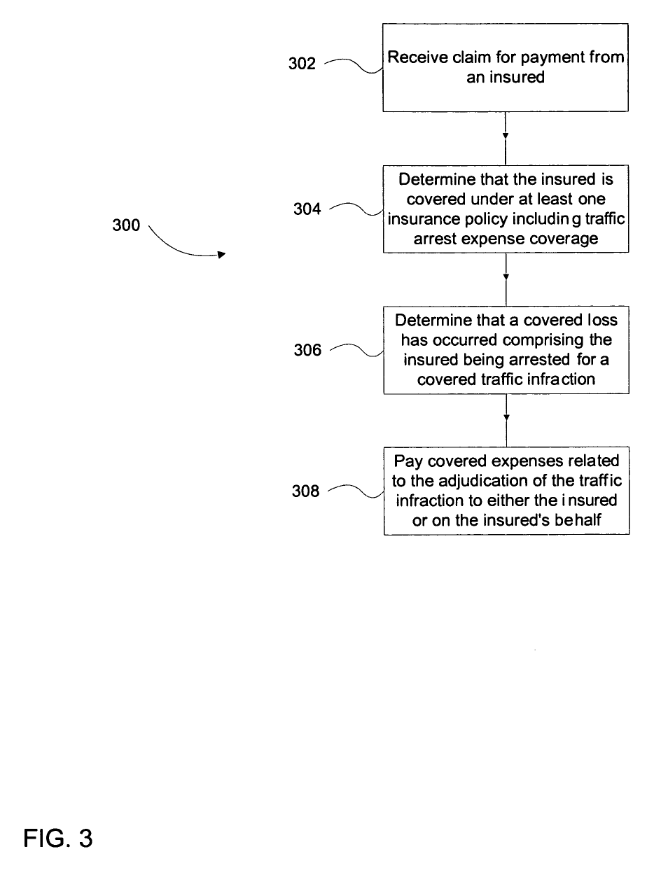

Referring to FIG. 3, a flowchart of a method 300 of paying traffic arrest related expenses under an insurance policy is depicted. At step 302, a claim for payment is received from an insured. At step 304, it is determined that the insured is covered under at least one insurance policy including traffic arrest expense coverage. At step 306, it is determined that a covered loss has occurred, the covered loss comprising the insured being arrested for a covered traffic infraction. At step 308, covered expenses related to the adjudication of the traffic infraction are paid either (i) to the insured or (ii) on the insured's behalf.

As before, the claim for payment may be received by an insurance company from an insured in a variety of manners. For example, the claim may be received in writing, in person, telephonically, or electronically. Also, the claim may be received directly from the insured, or alternatively may be received via an intermediary such as insurance agent. The determination that the insured is covered under a policy including traffic arrest expense coverage may involve a number of steps, including but not limited to those previously enumerated herein. For example, such a determination may include verification that the arrest occurred during an active policy period, that the insured is an insured under the policy, that all premiums have been paid, that the policy limits have not been exhausted and that no other exclusions apply. Similarly, determination of a covered loss may involve verifying that the charged offense is a covered offense under the policy.

Payment of the covered expenses may be made in a number of manners as well. Payment may be made directly to the insured, or to third parties on the insured's behalf, or both. Moreover, the payment of covered expenses may be a fixed amount (for example a policy limit amount), or may be a variable amount which varies based upon the total of expenses incurred or claimed. As before, the covered traffic related expenses may comprise a variety of expenses incurred as a consequence of the arrest and/or a conviction related to the traffic infraction charged.

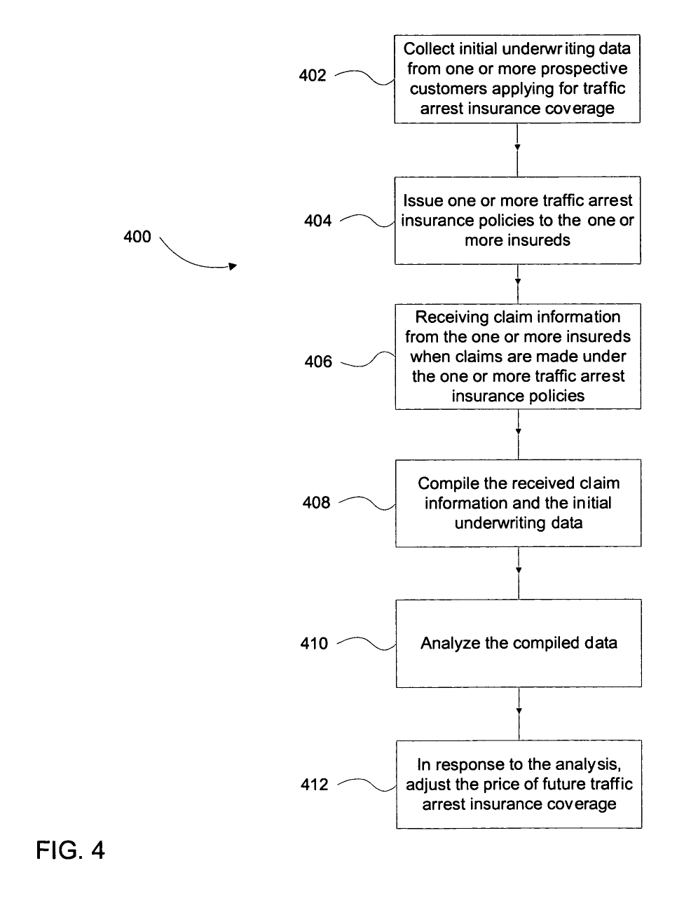

Referring to FIG. 4, a flowchart of a method 400 of collecting data for underwriting traffic arrest insurance coverage is depicted. At step 402, initial underwriting data is collected from one or more prospective customers applying for traffic arrest insurance coverage. At step 404, one or more traffic arrest insurance coverage policies is issued to the one or more insureds. The traffic arrest insurance coverage covers traffic arrest related expenses. At step 406, claim information from the one or more insureds is received when claims are made under the one or more traffic arrest insurance policies. At step 408, the received claim information and the initial underwriting data are compiled. At step 410, the compiled data is analyzed. At step 412, in response to the analysis, the price of future traffic arrest insurance coverage offered is adjusted.

The initial underwriting data collected from the insured may be collected in a variety of manners, including in writing, in person, telephonically, or electronically. Similarly, the claim information received may be received using any one or more of such methods. Any or all of such data may also be collected directly or via an intermediary, such as an insurance agent. Issuance of the policy, in an embodiment, comprises delivering to the one or more insureds a copy of the insurance policy as well as any associated riders, declaration pages, and accompanying documentation. The received claim information is used to refine and adjust the underwriting of such traffic arrest insurance policies which are offered in the future (either to the current insured or to other prospective customers.) The received claim information may be used to adjust policy limits, premium pricing, exclusions, definitions, covered losses, policy periods, or any other aspect of the policies. Moreover, the received claim information may be used to adjust the underwriting policies of other personal lines insurance products.

As used herein, personal lines insurance products include, but are not limited to, automobile liability policies, motorcycle policies, homeowners' policies, renter's insurance policies, and umbrella liability policies. Moreover, such personal lines products, such as automobile liability policies for example, may include owner's policies, non-owners policies, or both. As before, the covered traffic related expenses may comprise a variety expenses incurred as a consequence of the arrest and/or a conviction related to the traffic infraction charged.

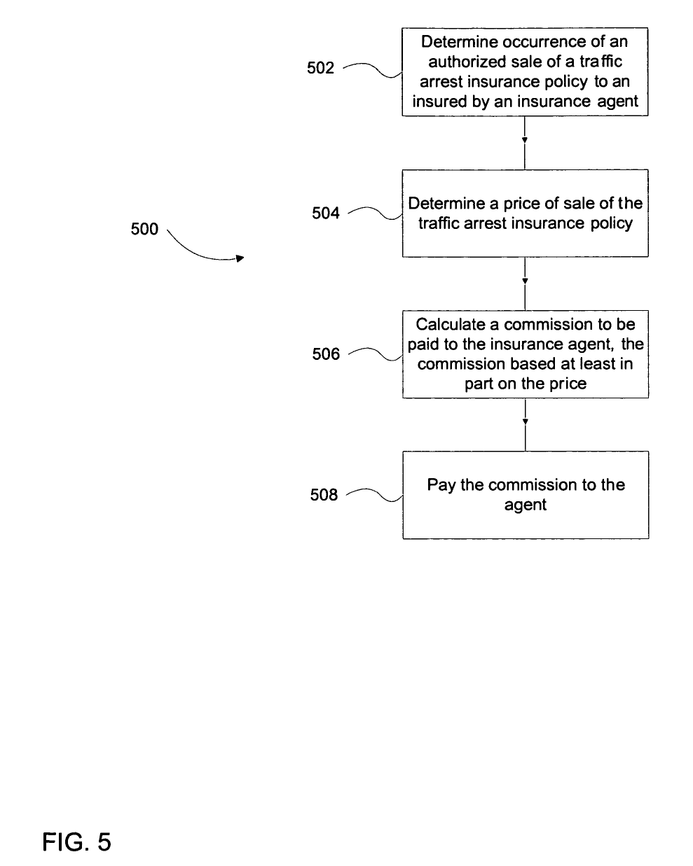

Referring to FIG. 5, a flowchart of a method 500 of compensating an insurance agent for selling traffic arrest insurance coverage is depicted. At step 502, a determination is made as to whether there has been an occurrence of an authorized sale of a traffic arrest insurance policy to an insured by an insurance agent. The traffic arrest insurance policy covers traffic arrest related expenses. At step 504, a price of sale of the traffic arrest insurance policy is determined. At step 506, a commission to be paid to the insurance agent is calculated. The commission is based at least in part on the price. At step 508, the commission is paid to the agent.

The determination of an authorized sale, in an embodiment, is made by determining that the sale was conducted in accordance with one or more sets of guidelines, rules, agreements, contracts, or policies governing insurance agents. In another embodiment, determination of an authorized sale may further include determination that relevant statues, regulations, laws, and ordinances have been complied with. The “price” of such a policy may also be referred to as the cost. This may be a wholesale cost (cost to the insurance company), a retail cost (cost to the insured), or an intermediate cost (cost to an intermediary such as an agent, prior to mark up).

A commission due to the agent may be calculated in a number of ways. For example, the commission may be a fixed amount. The commission may also be based upon the cost of the policy to be issued, such as percentage. In another embodiment, the commission may comprise a volume incentive. In yet another embodiment, the commission may comprise a loss-ratio incentive. Once calculated the commission is paid to the agent. The commission may be paid upon issuance of the policy, or at any other appropriate time (for example on periodic basis, e.g. monthly, for all such policies sold during the period). As with the other embodiments described herein, the covered traffic arrest related expenses may include a variety expenses incurred as a consequence of the arrest and/or a conviction related to the traffic infraction charged.

In some alternative embodiments, a variety of exclusions may be defined within such traffic arrest coverage insurance policies. Some example exclusions which may be defined therein are (i) whether the offense charged is on a list of enumerated offenses not covered, (ii) whether the insured was of legal drinking age, (iii) whether the insured was driving an owned vehicle, (iv) whether the offense occurred within a determined jurisdiction or area, (v) whether the insured was driving a covered vehicle, (vi) whether the loss occurred during the policy period, etc. Moreover, in some embodiments one or more deductibles may be imposed on the traffic arrest coverage such that one or more payments for covered losses under the policy are subject to (and thus reduced by) the deductible.

In another alternative embodiment of the invention, a conviction for a covered traffic offense may trigger coverage under such an insurance policy. The conviction may trigger coverage instead of or in addition to a traffic arrest as described herein. Thus, in one embodiment, no coverage is available to an insured who is arrested for a covered traffic offense, but not convicted. In other embodiments, coverage is provided to the insured who is arrested or convicted of a covered offense. Other variations are possible as well.

In some embodiments of the present invention, one or more policy or coverage premiums may be charged for the provided traffic arrest insurance coverage. In other words, the customer may be charged a separate policy or coverage amount relating to the traffic arrest insurance coverage. However, in other embodiments, the “cost” of the traffic related insurance coverage may be lumped in with other coverages (e.g. personal automobile coverage) such that the customer is not charged a separately defined or stated amount. The cost of the traffic related insurance is reflected in an increased policy premium for the other provided coverages (e.g. personal automobile coverage). In yet other embodiments, the traffic arrest insurance coverage may be provided to a customer at no additional charge so as to differentiate the insurer's products and gain market share through customer popularity and desirability of the additional coverage included as “standard.”

One or more steps of the above methods may be conducted on or performed with the assistance of computers, processors, and other digital equipment. Thus, one or more computer readable storage media may be encoded with instructions for performing the above described methods, and the steps therein. For example, a computer may be programmed to receive insurance requests, prompt and collect data, issue a traffic arrest insurance policy (or coverage), etc. Moreover, computer readable storage media may also be programmed with instructions for claims processing of such traffic arrest insurance policies, including receiving, analyzing and processing claim data and issuing payments attendant thereto. Thus, the methods may be performed manually, digitally with the assistance of a computing device, or both.

Although many of the examples used herein are related to personal lines insurance products, traffic arrest insurance coverage may be offered in conjunction with numerous types of commercial insurance products as well. For example, commercial automobile policies, commercial property coverage, general liability policies, and/or garage liability policies may be co-marketed, sold with or otherwise associated with the described traffic arrest coverage. Moreover, underwriting data and claims data collected in association with such traffic arrest coverage may be used to adjust premiums on such commercial policies as well, as described herein with reference to personal lines products.

It should be understood that although the steps of the methods 100, 200, 300, 400, 500 are depicted herein in the FIGURES having a particular order, such depictions are merely examples of the order of the steps of the methods. Such depictions are not intended to be the only order in which the steps of the methods 100, 200, 300, 400, 500 may be performed and are not limiting in any way.

Each of these embodiments and obvious variations thereof is contemplated as falling within the spirit and scope of the claimed invention, which is set forth in the following claims.

What is claimed is:

1. A method of insuring expenses related to a traffic arrest comprising:
collecting underwriting data from a prospective customer;
issuing an insurance policy to the prospective customer, the prospective customer becoming an insured under the insurance policy;
determining the occurrence of a covered loss, the covered loss comprising the insured being arrested for a traffic infraction included in a group of covered traffic infractions under the insurance policy; and
paying a first payment for the purposes of paying covered traffic infraction related expenses.

2. The method of claim 1, wherein the first payment is a predetermined amount paid to the insured.

3. The method of claim 2, wherein the predetermined amount is based upon a policy premium.

4. The method of claim 1, wherein the traffic infraction related expenses include traffic court fines.

5. The method of claim 1, wherein the traffic infraction comprises DUI.

6. The method of claim 1, further comprising receiving a policy premium from the insured.

7. The method of claim 1, wherein the first payment comprises an amount equal to a lesser of a policy limit or a total of covered traffic infraction related expenses submitted by the insured.

8. The method of claim 7, wherein the covered traffic infraction related expenses are selected from the group consisting of court costs, fines, bond, bail, rehabilitation programs, substance abuse programs, and vehicle impoundment expenses.

9. The method of claim 7, wherein the covered traffic infraction related expenses comprise criminal defense attorneys' fees.

10. The method of claim 1, further comprising declaring a policy limit of the insurance policy exhausted following payment of the first payment.

11. The method of claim 1, wherein the step of determining the occurrence of a covered loss comprises determining that (i) a person arrested is the insured, (ii) the arrest occurred during an effective term of the insurance policy, and (iii) the arrest is in the group of covered traffic offenses and not otherwise excluded.

12. A method of offering traffic arrest insurance comprising:
receiving a request for automobile insurance from a prospective customer;
collecting underwriting data from the prospective customer;
offering to the prospective customer supplemental insurance coverage comprising traffic arrest insurance, wherein the traffic arrest insurance covers traffic arrest related expenses;
receiving from the prospective customer acceptance of the offer of supplemental insurance; and
issuing both an automobile insurance policy and the supplemental coverage to the prospective customer wherein the prospective customer becomes an insured under the automobile insurance policy.

13. The method of claim 12, wherein the covered traffic infraction related expenses are selected from the group consisting of court costs, fines, bond, bail, rehabilitation programs, substance abuse programs, criminal defense attorneys' fees and vehicle impoundment expenses.

14. The method of claim 12, wherein the supplemental insurance coverage is provided by either (i) one or more endorsements to the automobile insurance policy or (ii) one or more optional coverages contained in the automobile insurance policy.

15. The method of claim 12, wherein the supplemental insurance coverage is provided as a standalone policy.

16. The method of claim 12, wherein the request is received from the prospective customer via an intermediary.

17. The method of claim 16, wherein the intermediary is an insurance agent.

18. A method of paying traffic arrest related expenses under an insurance policy comprising:
receiving a claim for payment from an insured;
determining that the insured is covered under at least one insurance policy including traffic arrest expense coverage covering traffic arrest related expenses;
determining a covered loss has occurred, the covered loss comprising the insured being arrested for a covered traffic infraction; and
paying covered expenses related to the adjudication of the traffic infraction either (i) to the insured or (ii) on the insured's behalf.

19. The method of claim 18, wherein the covered traffic infraction comprises DUI.

20. The method of claim 18, wherein the covered expenses comprise are selected from the group consisting of court costs, fines, bond, bail, rehabilitation programs, substance abuse programs, criminal defense attorneys' fees and vehicle impoundment expenses.
